(19) United States
(12) Patent Application Publication
(10) Pub. No.: US 2024/0161946 A1
(43) Pub. Date: May 16, 2024

(54) 3D INK PRINTING PROCESS FOR PRODUCING A COMPONENT WITH A CONDUCTOR BODY AND AN INSULATING BODY AND COMPONENT PRODUCED USING THE PROCESS

(71) Applicant: Nano Dimension Technologies LTD., Nes Ziona (IL)

(72) Inventors: Tobias Hehn, Oberthulba (DE); Felix Zimmer, Erding (DE); Jens Holtmannspötter; Andreas Salomon, München (DE); Rolf Baltes

(21) Appl. No.: 18/388,673

(22) Filed: Nov. 10, 2023

(30) Foreign Application Priority Data
Nov. 10, 2022 (DE) 10 2022 004 19
Mar. 2, 2023 (DE) 10 2023 000 785.4

(51) Int. Cl. H01B 13/016; B33Y 10/00; B33Y 80/00; H01B 11/18; H01B 13/06

(52) U.S. Cl. CPC H01B 13/016; B33Y 10/00; B33Y 80/00; H01B 11/18; H01B 13/067

(57) ABSTRACT

The invention relates to a 3D inkjet printing process for producing a component with a conductor body and an insulating body. The invention further relates to a component produced using the method. For reasons of simplicity, the application refers to the conductor body and the insulating body in the singular, which includes the plural.

### BACKGROUND

The invention relates to a 3D inkjet printing process for producing a component with a conductor body and an insulating body. The invention further relates to a component produced using the method. For reasons of simplicity, the application refers to the conductor body and the insulating body in the singular, which includes the plural and is not intended to exclude it.

A well-known one (https://www.nano-di.com/ame-materials) 3D ink printing process for producing a component with a conductor body and an adjacent insulating body has the following features.

The method uses a 3D inkjet printer with a first printhead for printing a solidifiable, conductive, first ink to form the conductor body and a second printhead for printing a non-conductive, solidifiable, second ink to form the insulating body. In the known inkjet printing process, the component is constructed with a conductor body and an insulating body made of individual layers. A layer is obtained by both printing and solidifying an ink. Layer by layer is applied one after the other. The process is as follows:
a) The first ink is used to print the conductive area of a layer.
b) The printed ink of the conductive area is solidified.
c) The second ink is used to print the non-conductive area of the layer.
d) The printed ink of the non-conductive area is solidified.
e) Approaching a new z position.
f) Continue accordingly with a) until the component is completed.

The first ink and the second ink are applied in a single layer in the respective designated areas. By placing the individual layers on top of each other, a component is created with a 3D arranged conductor body and insulation body. The disadvantage is that the outer surface of the conductor body is jagged. Due to the skin effect, a jagged outer surface has a detrimental effect on the high-frequency behavior because the impedance is greatly increased. One reason why the surface is jagged is since the first ink and the second ink have good wetting behavior. Small contact angles form. The printed ink drops are wide and flat. At the interface between conductive and non-conductive material, the mutual overlaps create a jagged interface. As a result, the conductor body takes on a structure similar to a Christmas tree. The skin effect causes a significant impedance increase in the fir-tree-like conductor body starting at just one GHz.

The object of the invention is to design a 3D ink printing process for producing a component with a conductor body and an insulating body adjacent thereto in such a way that the conductor body has a low impedance in the gigahertz range.

### SUMMARY

This object is achieved according to the invention by the features disclosed herein, which is directed to a method. Furthermore, this object is achieved according to the invention by the features of disclosed herein below, which is directed to a manufactured component.

The 3D ink printing process has the following features: the method uses a 3D inkjet printer with a first print head for printing a solidifiable, conductive, first ink to form the conductor body (10) and a second print head for printing a non-conductive, solidifiable, second ink to form the insulating body (20), with the procedural steps, that the conductor body (10) is formed from conductive layer blocks (B L1, B L2), such that each conductive layer block (B L1, B L2) consists of 2 to 16 conductive layers (S L1, S L2 . . . ) that these conductive layers (S L1, S L2 . . . ) are produced as a block successively and that each of these conductive layers (S L1, S L2 . . . ) is obtained by printing with the first ink and subsequent solidification, and that the insulation body (10) is formed from non conductive layer blocks (B N1, B N2), such that each non-conductive layer block (B N1, B N2) consists of 2 to 16 non-conductive layers (S N1, S N2 . . . ) that these non-conductive layers (S N1, S N2 . . . ) are produced as a block in succession and that each of these non-conductive layers (S N1, S N2 . . . ) is obtained by printing with the second ink and subsequent solidification, whereby a smooth outer surface of the conductor body (10) with low HF impedance is obtained.

The conductor body is formed from conductive layer blocks, such that each conductive layer block consists of 2 to 16, preferably 4 to 16 conductive layers, that these conductive layers are produced as a block in succession and that each individual one of these conductive layers is obtained by printing with the first ink and subsequent solidification, and that the insulating body is formed from non-conductive layer blocks, such that each non-conductive layer block consists of 2 to 16, preferably 4 to 16 non-conductive layers, that these non-conductive layers are produced as a block one after the other and that each individual one of these non-conductive layers is obtained by printing with the second ink and subsequent solidification.

Due to the layer blocks, a smooth outer surface of the conductor body with a low HF impedance is obtained. A small-scale interlocking in the manner of a zigzag profile between the individual adjacent conductive and non-conductive layers is significantly reduced. This effect could be demonstrated on a real component using modified software for printing preparation. The geometric shape of the outer surface of the conductor body is largely dependent.
on the properties of the ink of the first layer block produced in general,
specifically from the ability of this ink to form a wall that is as steep and smooth as possible, and
of the selected printing parameters.

According to an advantageous embodiment of the invention, successive ink drops of a respective layer of a first printed layer block are arranged at a respective offset at least in the adjacent edge region of a layer block to be subsequently printed out according to the specification of a control program. The predetermined offset of the successive ink drops ensures that the wall is as steep and smooth as possible. A large-scale interlocking in the manner of a zigzag profile between the individual adjacent conductive and non-conductive layers is significantly reduced. The first printed layer block forms a shape for the layer block to be subsequently printed out, so that the first printed layer block specifies the smoothness and steepness of the adjacent wall of the layer block to be subsequently printed out.

According to a further advantageous embodiment of the invention, the offset of the drops specified by the control program was determined by a previous numerical simulation of ink drops to be printed out. The simulation determines offset values that result in the steepest and smoothest possible wall.

According to an advantageous embodiment of the invention, the first ink comprises a metal particle suspension and the second ink comprises a photopolymer. When using these types of inks, a non-conductive layer block is first printed with the second ink and then an adjacent electrically conductive layer block is printed with the first ink. Because the polymer forms a smooth surface. Therefore, the non-conductive block is completed first. However, a worse but still usable result would be achieved if one were to first print a conductive layer block with the first ink. This is because the conductive particles in the suspension are subject to the Marangoni effect during drying, in which the particles collect in the edge area. The Marangoni effect results in surface roughness.

According to an advantageous embodiment of the invention, the conductor body formed from conductive layer blocks has an upper conductive layer block, which is flush with an upper, adjacent, non-conductive layer block of the insulating body. The flush finish provides a platform for subsequent layers. This is important when conductive and non-conductive layer blocks have an offset.

However, according to a further advantageous embodiment of the invention, it is preferred if the number of conductive layers of a conductive layer block is equal to the number of non-conductive layers of the adjacent, non-conductive layer block. This simplifies programming.

According to a further advantageous embodiment of the invention, the component is an HF component with a conductor body and an insulating body, in which the conductor body is a core of a coaxial line. The low impedance achieved is particularly important for this component.

These and other features of the methods for the direct and continuous fabrication of printed circuit boards (AMEs), will become apparent from the following detailed description when read in conjunction with the figures and examples, which are exemplary, not limiting.

### BRIEF DESCRIPTION OF THE FIGURES

For a better understanding of the direct additive manufacturing for printing of AMEs, their fabrication methods, with regard to the embodiments thereof, reference is made to the accompanying examples and figures, in which:

FIG. 1, shows a first, initial section of a first component with a conductor body and an insulating body, as a schematic diagram in section;

FIG. 2, shows a second component with a conductor body and an insulating body, as a detail and as a schematic sketch with cuts;

FIG. 3, shows a diagram of an intermediate result of numerical optimization simulations of ink drops to be printed, in which the individual simulated ink drops are shown in section along the x and z axes of the printer;

FIG. 4 is a diagram of a final result of numerical optimization simulations of ink drops to be printed, in which the individual simulated ink drops are shown in section along the x and z axes of the printer.

FIG. 5 shows a first initial section of a third component with a conductor body and an insulating body, but according to the prior art, as a schematic diagram in section; and

FIG. 6 shows a detail of a section of a fourth component with a conductor body and an insulating body, also according to the prior art, as a micrograph.

### DETAILED DESCRIPTION

Without initially referring to the drawings, all statements relate to a 3D ink printing process for producing a component with a conductor body and an insulating body adjacent to it.

The method uses a 3D inkjet printer with a first printhead for printing a solidifiable, conductive, first ink to form the conductor body and a second printhead for printing a non-conductive, solidifiable, second ink to form the insulating body. A single layer is obtained by printing with an ink and then solidifying.

The first, conductive ink in the examples is a metal particle suspension. The metal particles are silver nanoparticles, which are present as a suspension in a solvent. After applying the ink, the solvent is first evaporated using an infrared lamp and then the bed of silver particles is sintered. The at least partially sintered structure represents the conductive part of the printed electronics.

The second non-conductive ink is a light-curing polymer solution. The second ink has monomers that are stimulated to polymerize by ultraviolet radiation. A thermoset is created that acts as an insulating material.

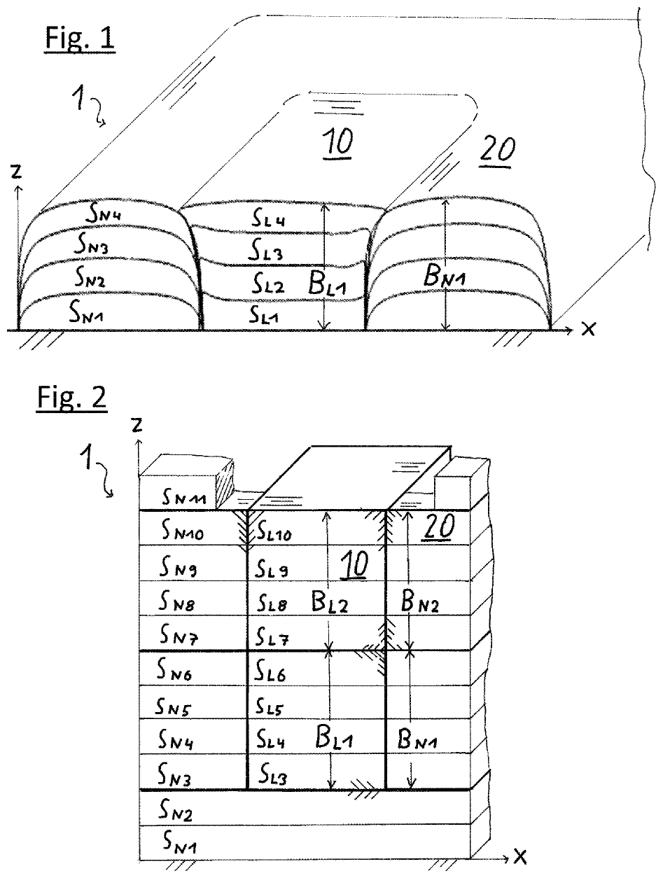

FIG. 1 illustrates a first, initial section of a first component 1 with a conductor body 10 and an insulating body 20. The initial conductor body 10 is formed from the conductive layer block B_{L1}. This electrically conductive layer block B_{L1} consists of exactly 4 conductive layers. The conductive layers are produced one after the other as a block. Each of these conductive layers S_{L1}, S_{L2}, S_{L3} and S_{L4} is obtained by printing with the first ink and then solidifying.

The initial insulation body 10 is formed from the non-conductive layer block B_{N1}. This non-conductive layer block B_{N1} also consists of 4 non-conductive layers. The non-conductive layers S_{N1}, S_{N2}, S_{N3} and S_{N4} are successively manufactured as a block. Each of these non-conductive layers is obtained by printing with the second ink and then solidifying. A smooth outer surface of the conductor body 10 with low HF impedance is obtained because the block formation greatly reduces interlocking.

In the present embodiment, the first ink comprises a metal particle suspension and the second ink comprises a photopolymer. A smooth outer surface of the conductor body is obtained if the non-conductive layer block B_{N1} is first printed with the second ink and then the adjacent electrically conductive layer block B_{L1} is printed with the first ink. Because the photopolymer forms a very smooth surface. This very smooth surface determines the shape of the outer surface of the conductor body.

FIG. 2, illustrates a second component 1 with a conductor body 10 and an insulating body 20. The conductor body 10 is formed from conductive layer blocks B_{L1} and B_{L2}. Each conductive layer block B_{L1} and B_{L2} consists of 4 conductive layers S_{L3} to S_{L6} and S_{L7} to S_{L10}. The conductive layers were fabricated sequentially as a block. Each of these conductive layers S_{L3} to S_{L6} and S_{L7} to S_{L10} was obtained by printing with the first ink and then solidifying. The insulation body 10 is formed from non-conductive layer blocks B_{N1} and B_{N2}. Each non-conductive layer block B_{N1} and B_{N2} consists of 4 non-conductive layers S_{N3} to S_{N6} and S_{N7} to S_{N10}. The non-conductive layers S_{N3} to S_{N6} and S_{N7} to S_{N10} were produced one after the other as a block. Each of these non-conductive layers was obtained by printing with the second ink and then solidifying. The block formation results in a smooth outer surface of the conductor body 10 with low HF impedance.

FIG. 2 further illustrates that the conductor body 10 formed from conductive layer blocks B_{L1} and B_{L2} has an upper conductive layer block B_{L2}, which is flush with an upper adjacent, non-conductive layer block B_{N2} of the insulating body 20. This creates a defined platform for subsequent layers. Likewise, the number of conductive layers S_{L3} to S_{L6} and S_{L7} to S_{L10} of a conductive layer block B_{L1}, B_{L2} is equal to the number of non-conductive layers S_{N3} to S_{N6} and S_{N7} to S_{N10} of the adjacent block, non-conductive layer blocks B_{N1} and B_{N2}. This makes programming easier.

Cuts carried out on manufactured component prototypes showed that the aforementioned measures already produce a sufficiently smooth outer surface of the conductor body with a low HF impedance. The outer surface of the conductor body can be further optimized with regard to a low HF impedance if you do not print ink drop by ink drop exactly on top of each other, but print offset from one another. For this purpose, the pressure of the individual ink drops was numerically simulated. In this simulation, ink drops lying on top of each other were printed, each with an offset from one another. This offset was varied with the aim of obtaining the steepest and smoothest possible wall while significantly reducing large-scale jagged formation.

The method provides that successive ink drops of a respective layer of a first printed layer block are arranged at a respective offset at least in the adjacent edge region of a layer block to be subsequently printed out according to the specification of a control program.

The method provides that successive ink drops of a respective layer of a first printed layer block are arranged at a respective offset at least in the adjacent edge region of a layer block to be subsequently printed out according to the specification of a control program.

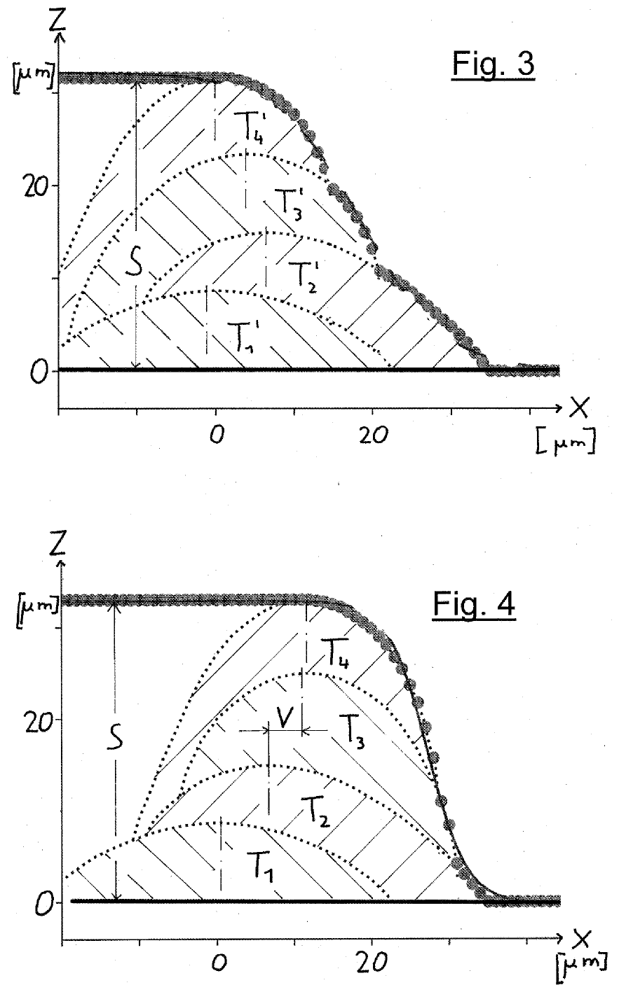

The method further provides that the respective offset of the successive ink drops specified by the control program was determined by a previous numerical optimization simulation of printed ink drops. Ink drops T′₁, T′₂, T′₃, T′₄ are illustrated in FIGS. 3, and 4 over the x and z axes of the printer. FIG. 4 shows a diagram of a final result of numerical optimization simulations of ink drops to be printed, in which the individual simulated ink drops T₁, T₂, T₃, T₄ are each shown in section over the x and z axes of the printer. In FIG. 4, the offset V between the ink drops T₂ and T₃ is shown as an example.

The offset V of the ink drops or, in other words, the offset of the positions of the ink drops enables the formation of a particularly steep interface between conductive and non-conductive material. For this purpose, the position of the ink drops is changed in the direction of the normal to the aforementioned interface by fractions of the drop diameter. In this example this is the x direction. Furthermore, in the present example, the tangential direction of the interface is the y-direction and the build-up direction is the z-direction.

Areas of application of the method include the production of HF components with a conductor body and an insulating body. In the HF component, the conductor body can be a core of a coaxial line.

The dimensioning of the layer height is discussed below. In the exemplary embodiment, a layer block consists of exactly 4 layers. Typical industrial inkjet printers have a horizontal resolution of 600 dpi (digits per inch). With 1 inch=25.4 mm, the voxels l have a point spacing of:

$$l = \frac{25.4 \frac{mm}{inch}}{600 \frac{1}{inch}} = 42.3 μ m$$

With a usual layer height of approx. 10.6 μm, it is easier to achieve the same resolution in all directions with a layer block of 4 layers. This results in the advantageous height of a layer:

$$layer height = \frac{42.3 μ m}{4 layers} = 10.6 μ m per layer$$

The dimensioning of the offset V of successive ink drops T₂ and T₃ illustrated in FIG. 4 will be discussed below. A drop of ink from the printer used has a volume of 4 picoliters. This corresponds to a radius of approx. 10 μm. Using a validated numerical flow simulation, it was found that a particularly good result is achieved with an offset V of the drop center in the range of 15 to 30% of the radius of the ink drop.

The simulation model was validated on the one hand through a comparison with the literature and on the other hand through a practical series of tests on the 3D printer. In the practical series of tests, the drop shapes were recorded three-dimensionally on an inclined plane using a confocal laser scanning microscope and compared with the simulation. An analysis of the deviations revealed a shape deviation of less than 500 nanometers, which corresponds to less than 10% of the drop height. The value of an offset or the offset position of an ink drop depends on a variety of parameters. These include, for example, the contact angle, dynamic viscosity, thermal conductivity, surface tension and temperature of the ink. The value of an offset also depends on the composition of the inks and the printer settings.

In deviation from the exemplary embodiments, modifications can be made. For example, the second, non-conductive ink can also be a ceramic suspension. Furthermore, if a different composition of inks is used, one could also start with the first ink if the first ink produces a smoother surface. The number of layers per block can also vary. A block can have 2 to 16, preferably 4 to 16 layers.

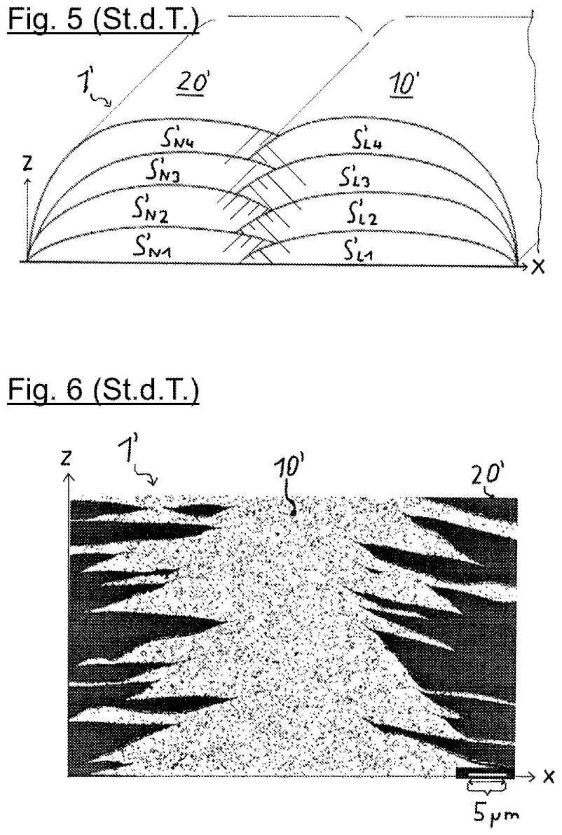

FIGS. 5 and 6 show the prior art. Each part of a component 1′ is shown with a conductor body 10′ and an insulating body 20′. FIG. 5 illustrates that at the interface of conductive to non conductive material there is a large-scale jagged interface due to mutual overlaps. This, in conjunction with an additional small-scale jagged interface, results in the Christmas tree-like structure of the conductor body 10′ in FIG. 6. The highly jagged outer surface of the conductor body 10′ causes a high impedance in the HF range.

With reference to FIG. 5, the mutual overlaps (“Christmass Tree Effect”) are caused by the following process:
a) The conductive area S′L1 of the first layer is printed with the first ink.
b) printed ink of the conductive area S′L1 of the first layer is solidified.
c) The non-conductive area S′N1 of the first layer is printed with the second ink.
d) The printed ink of the non-conductive area S′N1 of the first layer is solidified.
e) Approaching a new z position.
f) Continue following the steps mentioned above until component 1′ is completed.

FIG. 6 shows an enlarged micrograph of the printed component 1′. The image was taken after processing with an ion beam using a confocal laser scanning microscope. The conductor body 10′ is shown light and the insulation body 20′ is dark. The conductor body 10′ consists of a sintered silver nanoparticle suspension. The non-conductive insulation body 20′ consists of photopolymer. The cutting plane is an xz plane. The construction direction is the z direction. The dimensions and, in turn, the strength of the skin effect can be derived from the scale shown.

### REFERENCE SYMBOL LIST

1,1′ component
10,10′ conductor body
20, 20′ insulation body
S_{L1}, . . . , S′_{L1}, . . . each have a conductive layer
S_{N1}, . . . , S′_{N1}, . . . each a non-suffering layer
S layer in general, which can be both conductive and non-conductive
B_{L1}, B_{L2} first, second conductive layer block
B_{N1}, B_{N2} first, second non-conductive layer block
T₁, T₂, T₃, T₄ each one drop of ink
T′₁, T′₂, T′₃, T′₄ each one drop of ink
V offset

Although the foregoing disclosure has been described in terms of some embodiments, other embodiments will be apparent to those of ordinary skill in the art from the disclosure herein. Moreover, the described embodiments have been presented by way of example only, and are not intended to limit the scope of the inventions. Indeed, the novel methods, programs, libraries and systems described herein may be embodied in a variety of other forms without departing from the spirit thereof. Accordingly, other combinations, omissions, substitutions and modifications will be apparent to the skilled artisan in view of the disclosure herein.

What is claimed:

1. A method for producing a component with a conductor body and an insulating body (20) adjacent thereto, using a 3D inkjet printer with a first print head for printing a solidifiable, conductive, first ink to form the conductor body (10) and a second print head for printing a non conductive, solidifiable, second ink to form the insulating body (20) the method comprising:
a) forming the conductor body (10) from conductive layer blocks (B_{L1}, B_{L2}), such that each conductive layer block (B_{L1}, B_{L2}) consists of between 2 and 16 conductive layers (S_{L1}, S_{L2} . . . ) the conductive layers (S_{L1}, S_{L2} . . . ) formed as a block successively and wherein each of the conductive layers (S_{L1}, S_{L2} . . . ) is obtained by printing with the first ink and subsequent solidification;
b) forming the insulation body (10) from a non-conductive layer blocks (B_{N1}, B_{N2}), such that each non-conductive layer block (BN1, B_{N2}) consists of between 2 and 16 non-conductive layers (S_{N1}, S_{N2} . . . ), the non-conductive layers (S_{N1}, S_{N2} . . . ) are formed as a block in succession and wherein each of these non-conductive layers (S_{N1}, S_{N2} . . . ) is obtained by printing with the second ink and subsequent solidification; and
c) obtaining a smooth outer surface of the conductor body (10) with low HF impedance.

2. The Method of claim 1, wherein successive ink drops (T₁, T₂, T₃, T₄, T′₁, T′₂, T′₃, T′₄) of a respective layer (S) of a first printed layer block at least in the adjacent edge area to a layer block to be printed out afterwards, of the specification of a control program, can be arranged at a respective offset.

3. The method of claim 2, wherein the respective offset (V) of the successive ink drops (T₁, T₂, T₃, T₄, T′₁, T′₂, T′₃, T′₄) specified by the control program was determined by a previous numerical simulation of ink drops to be printed (T₁, T₂, T₃, T₄, T_{′1}, T′₂, T′₃, T′₄).

4. The method of claim 1, wherein the second ink comprises a photopolymer and wherein a non-conductive layer block (B_{N1}, B_{N2}) is first printed with the second ink and then an adjacent electrically conductive layer block (B_{L1}, B_{L2}) with the first ink.

5. The method of claim 4, wherein the conductor body 10 formed from conductive layer blocks (B_{L1}, B_{L2}) has an upper conductive layer block (B_{L2}) coupled to an upper adjacent, non-conductive layer block (B_{N2}) of the insulating body (B_{L2}) 20, is flush.

6. The method of claim 4, wherein the number of conductive layers (S_{L1}, S_{L2} . . . ) of the conductive layer block (B_{L1}, B_{L2}) is equal to the number of non-conductive layers (S_{N1}, S_{N1}) of the adjacent non-conductive Layer blocks (B_{N1}, B_{N2}).

7. A HF component with a conductor body (10) and an insulating body (20), manufactured using the method of claim 1.

8. The RF component of claim 7, wherein the conductor body (10) is a core of a coaxial line.
